(19) United States
(12) Patent Application Publication
(10) Pub. No.: US 2015/0142654 A1
(43) Pub. Date: May 21, 2015

(54) FACILITATING PAYMENT TRANSACTION VIA TRUSTED DEVICES

(71) Applicant: Kamal Zamer, Austin, TX (US)

(72) Inventors: Kamal Zamer, Austin, TX (US); Nikhil Vijay Thaker, Round Rock, TX (US)

(21) Appl. No.: 14/084,533

(22) Filed: Nov. 19, 2013

(51) Int. Cl. G06Q 20/32

(52) U.S. Cl. CPC G06Q 20/3278
USPC 705/44

(57) ABSTRACT

When a mobile communication device attempts to conduct an electronic payment transaction in a remote area where wireless signals for internet connection are not available, the mobile communication device may relay the request for payment transaction via one or more trusted devices using Near Field Communication to reach a trusted device that has access to the internet. In particular, the request for payment transaction may be relayed, e.g., daisy-chained, through one or more trusted devices until the request for payment transaction reaches a trusted device that has access to the internet. The trusted device that has access to the internet may send the request for payment transaction to a payment service provider via the internet to process the payment transaction.

### BACKGROUND

1. Field of the Invention

The present invention generally relates to systems and methods for facilitating payment transactions via trusted devices.

2. Related Art

With the proliferation of the internet, increasing numbers of payment transactions are made electronically via the internet. In particular, a payment service provider, such as PayPal, Inc. of San Jose, Calif. may provide services to facilitate a payment transaction between a payer and a payee. A payer or a payee may use a mobile communication device to connect, via the internet, to the payment service provider's server to request a payment transaction. The mobile communication device may connect to the internet via wireless communication, such as a WiFi router or a cellular tower. When the mobile communication device is in a remote area where no wireless communication signals are available for the mobile communication to connect to the internet, the mobile communication device may not be able to connect to the internet to conduct electronic payment transactions. Thus, there is a need for a system or method that facilitates electronic payment transactions using a mobile communication device when the mobile communication device is in a remote area where wireless communication signals are not available for connection to the internet.

### BRIEF DESCRIPTION OF THE FIGURES

FIG. 1 is a block diagram of a networked system suitable for implementing a process for facilitating electronic payment transactions via trusted devices according to an embodiment.

FIG. 2 is a flowchart showing a process for determining relay paths to internet connection according to one embodiment.

FIG. 3 is a flowchart showing a process for relaying payment transaction requests using trusted devices according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, when a mobile communication device attempts to conduct an electronic payment transaction in a remote area where wireless signals for an internet connection are not available, the mobile communication device may relay the request for payment transaction via one or more trusted devices to reach a trusted device that has access to the internet. In particular, the request for payment transaction may be relayed, e.g., daisy-chained, through one or more trusted devices until the request for payment transaction reaches a trusted device that has access to the internet. The trusted device that has access to the internet may send the request for payment transaction to a payment service provider via the internet to process the payment transaction.

In another aspect, the mobile communication device may log locations of a last available internet connection and nearby trusted devices. The mobile communication also may keep track of a traveling direction of the mobile communication device. Thus, the mobile communication may determine relay paths through trusted devices to access the internet based on the location of last connection to the internet, the travel direction of the mobile communication, and nearby trusted devices detected by the mobile communication device.

A trusted device may be a device registered at the payment service provider. In an embodiment, a trusted device may be a device that is in the same social or professional network as the mobile communication device. In still another embodiment, a trusted device may be a device that had previous interactions with the mobile communication device. For example, previous interactions may include emails, text messages, voice calls, payment transactions, or the like. The mobile communication may keep a history of other device that previously interacted with the mobile communication and may determine whether a device is a trusted device based on the history. In yet another embodiment, a trusted device may be a device that has the same service plan account, e.g., data or voice plan, as the mobile communication device.

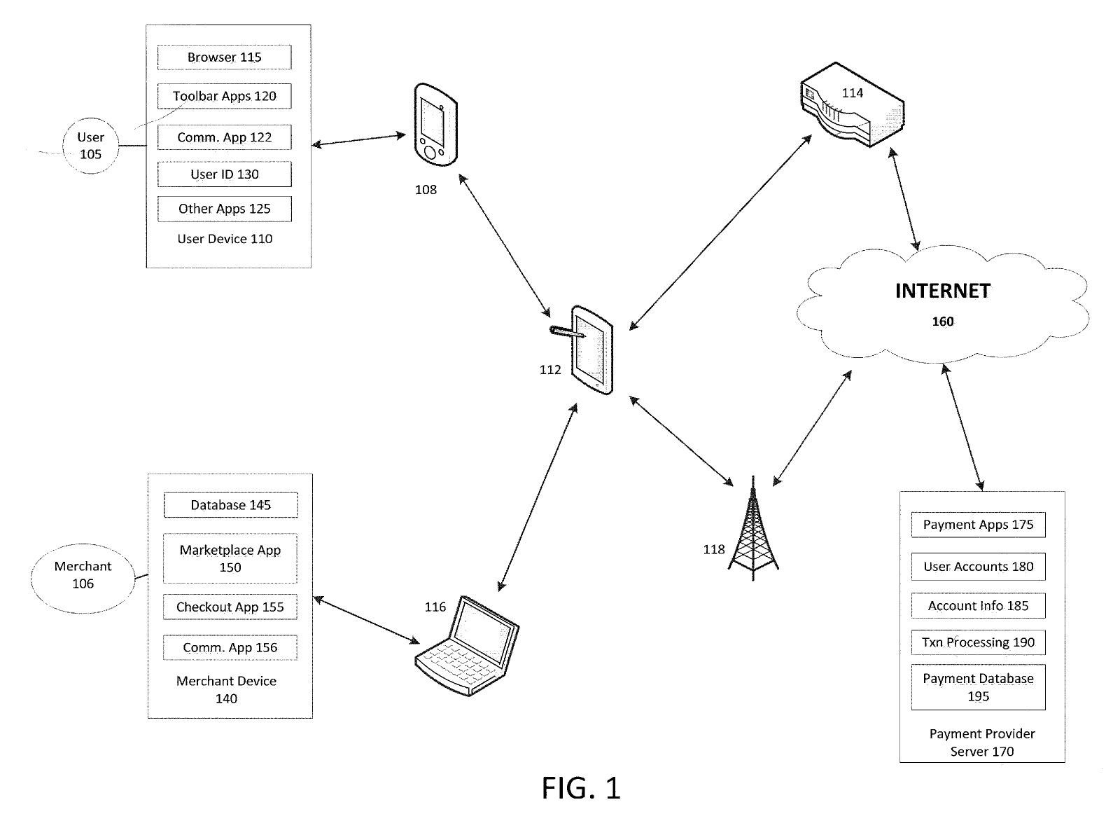

FIG. 1 is a block diagram of a networked system 100 suitable for implementing a process for facilitating electronic payment transactions via trusted devices according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant device 140, and a payment provider server 170 in communication over the internet 160. Payment provider server 170 may be maintained by a payment service provider, such as PayPal, Inc. of San Jose, Calif. A user 105 or a merchant 106 may utilize user device 110 or merchant device 140 to perform payment transactions using payment provider server 170. A user 105 may utilize user device 110 to initiate a payment transaction, receive a transaction approval request, or reply to the request.

In another aspect, a merchant 106 may use a merchant device 140 to initiate a payment transaction, receive a transaction approval request, or reply to the request. For example, when the user 105 makes a purchase from the merchant 106, the payment transaction for the purchase may be initiated by either the merchant 106 using the merchant device 140 or the user 105 using the user device 110. Note that transaction, as used herein, refers to any suitable action performed using the user device, including payments, transfer of information, display of information, etc. For example, user 105 may utilize user device 110 to initiate a deposit into a saving account.

System 100 also may include other communication devices 108, 112, and 116. When the user device 110 or the merchant device 140 does not have access to the internet 160, communication devices 108, 112, and 116 may be trusted devices that are configured to relay payment transaction requests from user device 110 or merchant device 140 to an internet router 114 or a cellular tower 118 that have access to the internet 160. The communication devices 108, 112, and 116 may be located between the user device 110 and the internet router 114 or between the merchant device 140 and the cellular tower 118.

User device 110, merchant device 140, payment provider server 170, and communication devices 108, 112, and 116 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over the internet 160.

User device 110 may be implemented using any appropriate hardware and software configured for wired and/or wireless communication in the system 100. For example, in one embodiment, the user device 110 may be implemented as a personal computer (PC), a smart phone, personal digital assistant (PDA), laptop computer, and/or other types of computing devices capable of transmitting and/or receiving data, such as an iPad™ from Apple™

The user device 110 may include one or more browser applications 115 which may be used, for example, to provide a convenient interface to permit user 105 to browse information available over the internet 160. For example, in one embodiment, browser application 115 may be implemented as a web browser configured to view information available over the internet 160, such as a user account for setting up a shopping list and/or merchant sites for viewing and purchasing products and services. User device 110 may also include one or more toolbar applications 120 which may be used, for example, to provide client-side processing for performing desired tasks in response to operations selected by the user 105. In one embodiment, toolbar application 120 may display a user interface in connection with browser application 115.

The user device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over the internet 160, or other types of applications.

Applications 125 may also include email, texting, voice and IM applications that allow user 105 to send and receive emails, calls, and texts through the internet 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider.

User device 110 may include a communications application 122, with associated interfaces, enables user device 110 to communicate within system 100. For example, the communications application 112 may be configured to manage and implement wired communication, such as Ethernet communication and/or telephone landline communication, and wireless communication, such as WiFi communication, Bluetooth communication, cellular voice and/or data communication, Near-Field Communication (NFC), and the like.

User device 110 also may include applications that collect location data using Global Positioning System (GPS) to identify a location of user device 110. User device 110 may have a magnetometer configured to detect a moving or traveling direction of user device 110. Other means for collecting location data, such as WiFi devices, Near-Field Communication (NFC) devices, or the like also may be included in user device 110 for determining a location of user device 110. Thus, user device 110 may determine a current location of user device 110 and track a traveling direction of the user device 110 based on the collected location data.

Merchant device 140 may be maintained, for example, by a merchant or seller offering various products and/or services. The merchant may have a physical point-of-sale (POS) store front. The merchant may be a participating merchant who has a merchant account with the payment service provider. Merchant device 140 may be used for POS or online purchases and transactions. Generally, merchant device 140 may be maintained by anyone or any entity that receives money, which includes charities as well as banks and retailers. For example, a payment may be a donation to charity or a deposit to a saving account.

Merchant device 140 may include a database 145 identifying available products (including digital goods) and/or services (e.g., collectively referred to as items) which may be made available for viewing and purchase by user 105. Accordingly, merchant device 140 also may include a marketplace application 150 which may be configured to serve information over the internet 160 to browser 115 of user device 110. In one embodiment, user 105 may interact with marketplace application 150 through browser applications over the internet 160 in order to view various products, food items, or services identified in database 145.

Merchant device 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over the internet 160. For example, checkout application 155 may receive and process a payment confirmation from payment service provider server 170, as well as transmit transaction information to the payment provider and receive information from the payment provider via the internet 160. Checkout application 155 may be configured to receive payment via a plurality of payment methods including cash, credit cards, debit cards, checks, money orders, or the like.

Merchant device 140 may include a communications application 156, with associated interfaces, enables merchant device 140 to communicate within system 100. For example, the communications application 156 may be configured to manage and implement wired communication, such as Ethernet communication and/or telephone landline communication, and wireless communication, such as WiFi communication, Bluetooth communication, cellular voice and/or data communication, Near-Field Communication (NFC), and the like.

Payment provider server 170 may be maintained, for example, by an online payment service provider which may provide payment between user 105 and the operator of merchant device 140. In this regard, payment provider server 170 may include one or more payment applications 175 which may be configured to interact with user device 110 and/or merchant device 140 over the internet 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant device 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant device 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

The internet router 114 may be a wired and/or wireless router that has access to the internet 160. The internet router 114 may have a wireless broadcast range within which communication devices may access the internet router 114 wirelessly to connect to the internet 160. For example, the communication device 112 may be a tablet that is located within the wireless broadest range of the internet router 114. Thus, the communication device 112 may connect to the internet router 114 to access the internet 160. In contrast, the communication device 108 may be a mobile phone that is located outside of the wireless broadcast range of the internet router 114. Thus, the communication device 108 may not connect to the internet router 114 directly to access the internet 160.

The communication device 112 may have a wireless broadcast range within which other devices may communicate with the communication device 112. For example, the communication device 108 may be located within the wireless broadcast range of the communication device 112. Thus, the communication device 108 may communicate with the communication device 112. As such, the communication device 108 may access the internet 160 indirectly via the communication device 112, which may connect to the internet router 114.

The user device 110 may be located within the wireless broadcast range of the communication device 108 but outside of the wireless broadcast range of the communication device 112. When the user 105 initiates a payment transaction request at the user device 110, the payment transaction request may be relayed from the user device 110 to communication device 108, the communication device 112, through the internet router 114, and to the payment provider server 170 via the internet 160. Thus, even though the user device 110 is located in a remote area where internet access is not available, the user device 110 may relay the payment transaction request through trusted devices, e.g., communication devices 108 and 112, to the internet router 114 to access the internet 160 to send the payment transaction request to the payment provider server 170.

The cellular tower 118 may be operated by a cellular data service provider. The cellular tower 118 may be configured to manage communication for cellular devices located within the cellular tower 118's broadcast range. The cellular tower 118 may have access to the internet 160 and may provide internet access to cellular devices within the cellular tower 118's broadcast range. The communication device 112 may be located within the broadcast range of the cellular tower 118 and configured to facilitate cellular data communication with the cellular tower 118. Thus, the communication device 112 may access the internet by connecting to the cellular tower 118. The communication device 116 may be a laptop computer located outside of the broadcast range of the cellular tower 118 but within the wireless broadcast range of the communication device 112. Thus, the communication device 116 may connect to the communication device 112 to access the internet 160 indirectly.

The merchant device 140 may be in a remote area that has no internet access. When the merchant 106 initiates a payment transaction request at the merchant device 140, the merchant device 140 may relay the payment transaction request through trusted devices, such as the communication device 116 and the communication device 112, to reach the cellular tower 118 or the internet router 114 to access the internet 160 and send the payment transaction request to the payment provider server 170. Thus, even though the merchant device 140 is located in a remote area where internet access is not available, the merchant device 140 may relay the payment transaction request through trusted devices, e.g., communication devices 116 and 112, to the internet router 114 or the cellular tower 118 to access the internet 160 in order to send the payment transaction request to the payment provider server 170.

The communication devices 108, 112, and 116, the user device 110, and the merchant device 140 may be trusted devices that are registered at the payment provider server 170. These devices may each be configured to execute processes that facilitate relaying of payment transaction information when internet connection is not available. In particular, when a communication device attempts to initiate a payment transaction request in a remote area where internet access if not available to the communication device, the communication device may relay the payment transaction request through nearby trusted devices until the payment transaction request reaches a trusted device that has access to the internet. Thus, the payment transaction request may be transmitted to the payment provider server 170 by relaying through the trusted devices.

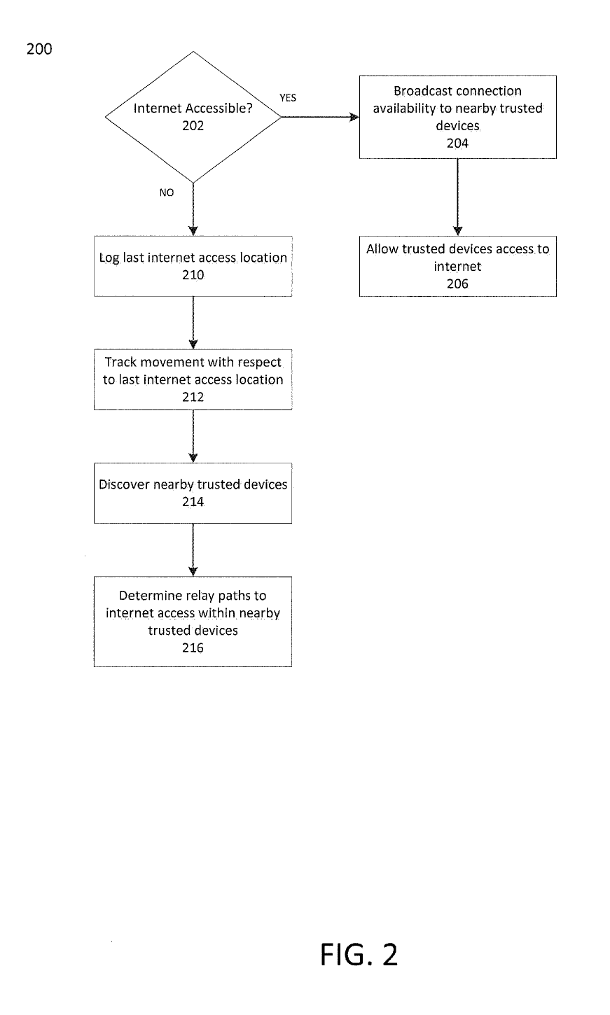

FIG. 2 is a flowchart showing a process 200 for determining relay paths to an internet connection according to one embodiment. The process 200 for determining relay paths may be executed by each of the communication devices registered at the payment provider server 170, such as the user device 110, the merchant device 140, and the communication devices, 108, 12, and 116. For example, each communication device may download a payment transaction application from the payment provider server 170. The payment transaction application may register the communication device to the payment provider server 170 and may enable the communication device to utilize the payment service at the payment provider server 170. The payment transaction application also may execute the process 200 to determine relay paths to internet connection using nearby registered devices when direct connection to the internet is not available.

At step 202, a communication device may determine whether direct internet access is available. For example, the communication device may determine whether cellular data service is available by detecting a cellular signal. The communication device also may determine whether WiFi service or Ethernet connection is available for connection to the internet. If internet connection is available to the communication device, the communication device may broadcast connection availability to nearby trusted devices at step 204. For example, as shown in FIG. 1, communication device 112 has internet access via either the internet router 114 or the cellular tower 118. Thus, communication device 112 may broadcast a signal, e.g., a WiFi signal, a Bluetooth signal, or an NFC signal, to inform nearby registered devices, such as communication devices 108 and 116, that communication device 112 has internet access.

At step 206, the communication device may allow nearby trusted devices to access the internet 160 via the communication device. As shown in FIG. 1, the communication device 112 has internet connection via either the internet router 114 or the cellular tower 118. Thus, the communication device 112 may allow nearby communication devices 108 and 116 to connect to the communication device 112 to access the internet 160 indirectly. Thus, even though communication devices 108 and 116 are not located in the broadcast range of either the internet router 114 or the cellular tower to have internet access, the communication devices 108 and 116 may be located within the broadcast range of communication device 112 to access the internet 160 via the communication device 112. In particular, the communication device 112 may receive payment transaction requests from the communication devices 108 and 116 and forward the payment transaction requests to the payment provider server 170 via the internet 160.

If at step 202, the communication device does not have internet access, the communication device may log a location where it last had internet connection at step 210. For example, assuming that the user device 110 was previously connected to the internet via the internet router 114 and lost internet connection when the user 105 moved the user device 110 away from the broadcast range of the internet router 114. The user device 110 may create a log indicating that the last internet connection was at the internet router 114. The user device 110 also may use a GPS device to detect the geographical location of where the user device 110 lost the internet connection.

At step 212, the communication device may track the movement and/or travel directions of the communication device. The communication device may track the movement and travel direction of the communication device using a magnetometer. Thus, the communication device may track a traveling path of the communication device after internet connection is lost. For example, when the user device 110 departs from the broadcast range of the internet router 114, the user device 110 may track the movement and the travel direction of the user device 110 using a GPS device and a magnetometer included in the user device 110. Thus, the user device 110 may determine a returning path or direction back to the last location where the user device 110 had internet connection.

At step 214, the communication device may discover nearby trusted devices. The trusted devices may be communication devices that are registered with the payment provider server 170 and are configured to execute the same payment transaction application provided by the payment provider server 170. In some embodiments, trusted devices may be devices of friends in an online social network, devices that share a family cellular plan, devices that had frequent communication, and the like. When the communication device departs from an internet accessible location, the communication device may begin to detect and search for other nearby trusted devices via wireless signals, such as WiFi, Bluetooth, or NFC signals.

The communication device may save the location where each of the trusted devices is detected. The communication device may keep a travel log of locations visited and trusted devices found at each locations. For example, as the user device 110 moves away from the broadcast range of the internet router 114, the user device 110 may begin to detect NFC signals from nearby trusted devices. The user device 110 may first detect a WiFi signal from the communication device 112 and remember the location where the communication device 112 is detected. As the user device 110 is moved further from the internet router 114, the user device 110 may also detect a Bluetooth signal from the communication device 108 and may remember the location where the communication device 108 is detected. Similarly, the communication device 108 also may execute the process 200 to detect the user device 110 and remember the location where the user device 110 is detected.

At step 216, the communication device may use the information collected in steps 210, 212, and 214 to determine a relay path directing back to the last location where internet access is available. For example, the user device 110 may attempt to determine a relay path back to the location within the broadcast range of internet router 114. Using the travel log, the user device 110 may back-track the path the user device 110 had traveled since leaving the internet connection at internet router 114. The user device 110 may determine a relay path of: communication device 108, to communication device 112, to internet router 114. Thus, the user device 110 may utilize the relay path to forward a payment transaction request to the payment provider server 170 via trusted devices.

As noted above, trusted devices, such as user device 110, merchant device 140, and communication devices 108, 112, and 116, that are registered with the payment provider server 170, may each execute process 200 to determine one or more potential relay paths to gain internet access indirectly when no direct internet access is available.

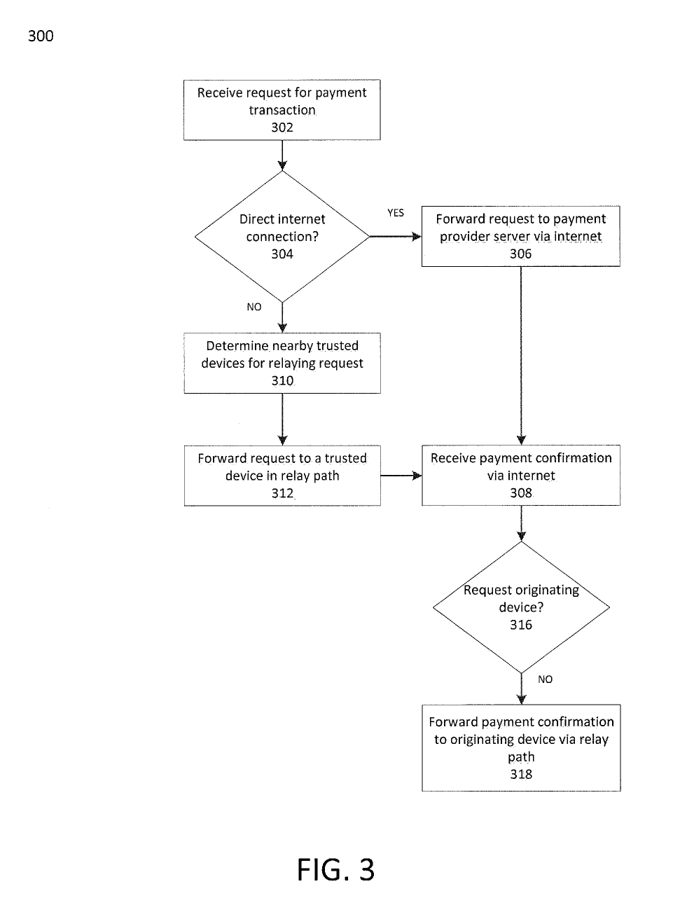

FIG. 3 is a flowchart showing a process 300 for relaying payment transaction requests using trusted devices according to one embodiment. The process 300 may be executed by communication devices registered with payment provider server 170. At step 302, the communication device may receive a request for payment transaction. For example, the user device 110 may receive a payment transaction request from the user 105 when the user 105 is paying for a purchase. In another aspect, the communication device 108 may receive a payment transaction request relayed from the user device 110. Thus, the payment transaction request may be received either from a user or from another trusted communication device.

The payment transaction request may include information of the user's, e.g., payer's, payment account information, such as account ID and password, payment method, payment amount, description of product or service being purchased, time, date, and location of the purchase, the payee's account information.

At step 304, the communication device may determine whether the communication device itself has direct connection to the internet. The communication device may access the internet through wired connection, such as telephone line or Ethernet, or wireless connection, such as WiFi or cellular data network. If the communication device has direct internet connection at step 306, the communication device may forward the payment transaction request to the payment provider server 170 via the internet 160 at step 306. For example, when the communication device 112 receives a payment transaction request, the communication device 112 may forward the payment transaction request to the payment provider server via its direct connection to the internet 160, because the communication device 112 has internet connection via an internet connection terminal, e.g., the internet router 114 or the cellular tower 118.

If the communication device does not have direct internet connection at step 304, the communication device may determine a nearby trusted device for relaying the payment transaction request at step 310. In particular, the communication device may determine a nearby trusted device to relay the request based on the location of last internet connection, the travel directions and locations in the travel log, and the trusted devices detected at travel locations, e.g., information collected in steps 210, 212, 214, and 216. The communication device may first determine trusted devices that are within the wireless communication range of the communication device. The communication device may first select a trusted device that has direct internet connection. For example, communication device 108 may select communication device 112 as the trusted device to relay the payment transaction request, because communication device 112 has direct internet connection. If none of the nearby trusted devices have direct internet connections, the communication device may select a trusted device based on the travel log and a direction of the location where the communication device last had Internet connection. For example, neither communication device 108 nor communication device 116 near user device 110 has internet connection, the user device 110 may select communication device 108 as the trusted device to relay the payment transaction request, because communication device 108 is closest to the direction where user device 110 last had internet connection at internet router 114.

At step 312, the communication device may forward the payment transaction request to the trusted device determined in step 310. The same process 300 may be executed at each communication device. For example, the user device 110 may determine that communication device 108 is closest to the direction of last internet connection and may forward the payment transaction request to communication device 108. The communication device 108 may determine that communication device 112 has direct connection to the internet and may relay the payment transaction request received from the user device 110 to communication device 112.

The payment transaction request may be encrypted at the communication device that generated and initiated the request, such that the payment transaction request may be protected from being read by communication devices that relay the payment transaction request. For example, the user device 110 may encrypt the payment transaction request with a user ID and/or password of the user 105. In another aspect, the unique key may be generated for the user device 110 when the user device 110 is registered at the payment provider server 170. The unique key may be used to encrypt the payment transaction request. The encrypted payment transaction request may be relayed through trusted devices 108 and 112 to reach the payment provider server 170. The payment provider server 170 may have the user 105′s user ID and/or password when the user 105 registered the user device 110 at the payment provider server 170. The payment provider server 170 may use the user ID and/or password to decrypt the payment transaction request. Thus, the payment transaction request may be relayed through the trusted devices securely.

In step 312, the communication device may add the communication device's identification to the payment transaction request when forwarding the payment transaction request. Thus, the payment transaction request may have a tracking list of communication devices through which the payment transaction request has been relayed. For example, the payment transaction request may indicate that the user device 110 is the originating device. Further, when the communication device 108 relays the payment transaction request, the communication device 108 may add the identification of the communication device 108 to the payment transaction request. Similarly, the communication device 112 also may add its own ID to the request when relaying the request. Thus, the payment transaction request may have a tracking list of devices including: user device 110, communication device 108, and communication device 112, in that order. The tracking list may be used later to return a payment confirmation from the payment provider server 170 back to the user device 110.

At step 308, the communication device may receive a payment confirmation originated from the payment provider server 170. For example, after the payment provider server 170 completes processing the payment transaction, the payment provider server 170 may generate and send a confirmation back to the user device 110. The payment confirmation may be returned back to the user device 110 using the tracking list. For example, the payment provider server 170 may send the confirmation to the last communication device on the tracking list.

At step 316, the communication device may determine whether the communication device is the request originating device. A request originating device may be a communication device that originates the payment transaction request. For example, the user device 110 may be a request originating device, because the user 105 uses the user device 110 to initiate and generate a payment transaction request. The communication device 112 may not be a request originating device, because the communication device 112 does not initiate the payment transaction request but merely is one of the trusted devices that relay the payment transaction request to the payment provider server 170. For example, the payment confirmation may have the tracking list and the communication device may determine if the communication device is the first communication device on the tracking list, e.g., the final destination of the confirmation.

If the communication device is a request originating device, the communication device may end the relay process after receiving the payment confirmation. In response to receiving the payment confirmation, the communication device may inform the user that the payment transaction has been completed by displaying the payment confirmation to the user. For example, when the user device 110 receives the payment confirmation from the communication device 108, the user 110 may end the relay process and may display a message notifying the user 105 that the payment has been processed.

If the communication is not the request originating device, the communication device may relay the payment confirmation to the next communication device on the tracking list at step 318. For example, when communication device 108 receives the payment confirmation, the communication device 108 may determine that communication device 108 is not the request originating device and may forward the payment confirmation to the user device 110, which may be the next device on the tracking list.

By using the above process 300, each communication device may facilitate the transmission and relaying of a payment transaction request from a request originating device, such as user device 110 or merchant device 140, to payment provider server 170. Further, the payment provider server 170 may send a payment confirmation back to the request originating device using the same relaying path.

The following are exemplary scenarios in which the above processes 200 and 300 may be implemented.

### EXAMPLE 1

The user stays at a beach resort in a remote area and would like to take a banana boat ride at the beach. The resort is a few miles from town in a remote area. The resort has spotty cellular network coverage and a few WiFi access spots. The merchant of the banana boat ride accepts electronic payment. The user uses a credit card to pay for the boat ride. When the user swipes the credit card at the merchant's device, the merchant device attempts to process the payment transaction. Since the merchant device is on the beach and out of range of data or internet networks, e.g., 4G, LTE, WiMax, WiFi, and etc., the merchant device will have to find a way to reach the nearest internet access point. Thus, the merchant device searches for other nearby trusted devices using NFC, e.g., Bluetooth or peer-to-peer WiFi.

The merchant's device detected a few communication devices within a few yards inside a small restaurant serving patrons near the beach. One of the communication devices is a smartphone belonging to one of the restaurant owners. The restaurant owner is a registered merchant with the payment service provider and is therefore a trusted device. The merchants in the beach resort area are all registered merchants and all are “trusted devices” which may be used to relay payment transaction requests. The merchant device decides to use the restaurant owner's phone as a link in the relay chain.

The merchant device is generally looking to relay the payment transaction request in an eastward direction because the merchant device had moved westward since the last time the merchant device was connected to the internet. The restaurant owner's cellphone will search for WiFi or other network coverage. Again there is no network coverage. The restaurant owner's cellphone then will use NFC to discover other trusted devices. The restaurant owner's cellphone discovers that cellphones of friends of the restaurant owner are at a lawn chair area a few yards away from the restaurant. The lawn chair area is fairly close to the hotel. The restaurant owner and his friends are also friends on a social network. Thus, the cellphones of the restaurant owner's friends are trusted devices.

The payment transaction request thus continues to be relayed from the Banana Boat merchant→The restaurant owner→friends in lawn chair area. The lawn chair area is near the hotel. The cellphones of friends look for internet connection from the lawn chair area and discovers that the hotel's WiFi is active and running. Thus, the cellphone of friends at the lawn chair area may use the hotel's WiFi network to connect to the internet and may forward the payment transaction request to the payment service provider via the internet. The payment transaction request effectively is relayed all the way from the Banana Boat merchant to the hotel: banana boat merchant→the restaurant owner→lawn chair friends→

Hotel's WiFi. Thus, this relay path may be used to authorize the payment.

In another example, the user may pay for the ride with his own cellphone rather than a credit card. Thus, the user's cellphone may initiate the payment transaction request. If the relay path from the merchant device fails, then a relay path could attempted to be formed from then user's cellphone. Trusted devices from the user's cellphone could include public rest areas and merchants where the user has made purchases prior to visiting the Banana Boat. After the payment is authorized and finalized using the user's cellphone, the user's cellphone may use NFC to transfer the payment data to the merchant's device.

By using the above systems and methods, electronic payment transactions may be made even in areas where internet connection is not available. Further, the communication devices may remember the location of last internet connection and may determine a relay path in a specific general direction to find an internet connection in an efficient manner.

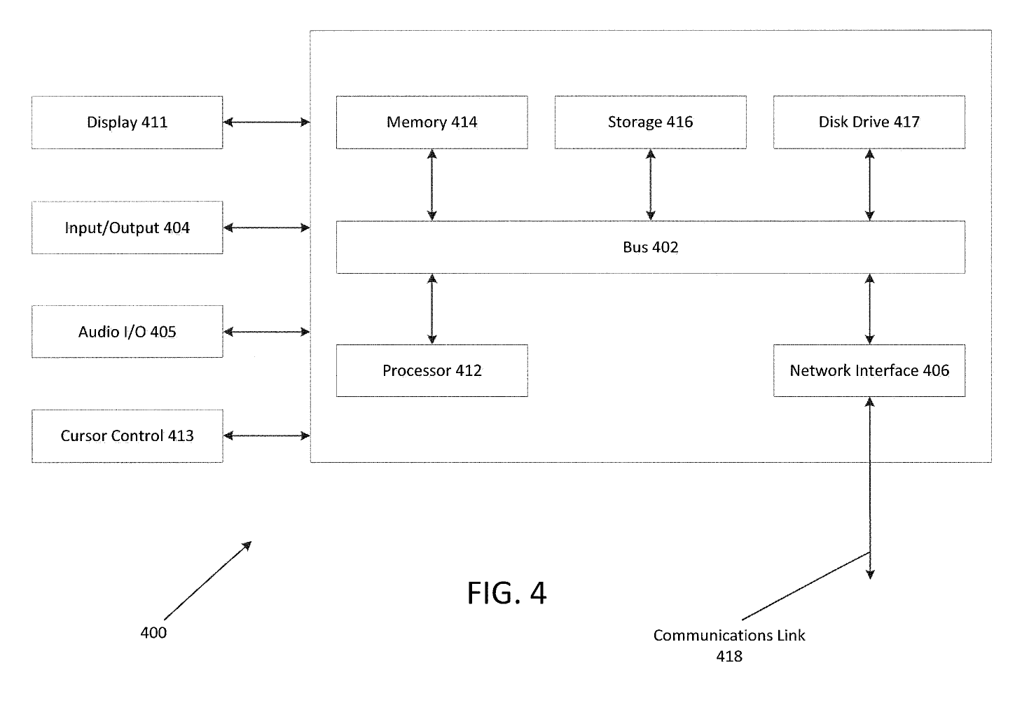

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with other communication devices and the internet 160. The merchant and/or payment provider may utilize a network computing device (e.g., a network server) capable of communicating with other communication devices and the internet 160. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A payment provider server configured to facilitate payment transactions via trusted devices, the payment provider server comprising:
a hardware memory storing information about a payment account of a user, and
one or more processors in communication with the memory and adapted to:
receive a payment transaction request for making a payment using the payment account of the user initiated by a user's device and relayed through one or more trusted devices using Near Field Communication (NFC);
process the payment transaction request using the payment account of the user; and
send a payment confirmation to the user's device.

2. The payment provider server of claim 1,
wherein the payment transaction request includes a tracking list indicating a relay path of the payment transaction request through the one or more trusted devices, and
wherein the one or more processors are further adapted to send the payment confirmation to the user's device via the one or more trusted devices based on the tracking list.

3. The payment provider server of claim 1,
wherein the payment transaction request is encrypted at the user's device, and
wherein the one or more processors are further adapted to decrypt the payment transaction request.

4. The payment provider server of claim 1,
wherein the user's device is located in an area where internet connection is not available to the user's device;
wherein the payment transaction request is relayed from the user's device through the one or more trusted devices to reach an internet connection point.

5. The payment provider server of claim 1, wherein the one or more processors are further adapted to send the payment confirmation to the user's device through the one or more trusted devices.

6. The payment provider server of claim 1, wherein the one or more processors are further adapted to send the payment confirmation directly to the user's device when the user's device has internet connection.

7. A communication device configured to facilitate payment transactions via trusted devices, the communication device comprising:
one or more processors adapted to:
receive a payment transaction request for making a payment using a user's payment account;
determine whether the communication device has internet connection;
determine a trusted device for relaying the payment transaction request to a payment provider server via the internet when the communication device has no internet connection; and
send the payment transaction request to the trusted device via Near Field Communication (NFC).

8. The communication device of claim 7, wherein the one or more processors are further adapted to:
store a last location where the communication device has internet connection
track traveling locations and directions of the communication device with respect to the last location in a traveling log;
detect one or more trusted devices located near the communication device;
select the trusted device for relying the payment transaction request from the one or more trusted devices based on the last location and the traveling log.

9. The communication device of claim 7, wherein the trusted device is registered at the payment provider server.

10. The communication device of claim 7, wherein the trusted device and the communication device are in a same social network.

11. The communication device of claim 7, wherein the one or more processors are further adapted to:
receive a user instruction to initiate the payment transaction request;
generate the payment transaction request based on the user instruction; and
encrypt the payment transaction request with an encryption key stored at the payment provider server.

12. The communication device of claim 7, wherein the one or more processors are further adapted to add an identification of the communication device to a tracking list included with the payment transaction request when sending the payment transaction request to the trusted device.

13. The communication device of claim 12, wherein the one or more processors are further adapted to:
receive a payment confirmation generated by the payment provider server confirming processing of the payment transaction request;
determine whether the communication device is the request originating device based on the tracking list included in the payment confirmation; and
send the payment confirmation to a next trusted device based on the tracking list if the communication device is not the request originating device.

14. The communication device of claim 13, wherein the one or more processors are further adapted to notify the payment confirmation to a user of the communication device if the communication device is the request originating device.

15. A method for facilitating payment transactions via trusted devices, the method comprising:
receiving, at a communication device, a payment transaction request for making a payment using a user's payment account;
determining whether the communication device has internet connection;
determining a trusted device for relaying the payment transaction request to a payment provider server via the internet when the communication device has no internet connection; and
sending the payment transaction request to the trusted device via Near Field Communication (NFC).

16. The method of claim 15 further comprising:
storing a last location where the communication device has internet connection;
tracking traveling locations and directions of the communication device with respect to the last location in a traveling log;
detecting one or more trusted devices located near the communication device; and
selecting the trusted device for relying the payment transaction request from the one or more trusted devices based on the last location and the traveling log.

17. The method of claim 15, wherein the trusted device is registered at the payment provider server.

18. The method of claim 15, wherein the trusted device and the communication device are in a same social network.

19. The method of claim 15 further comprising:
receiving a user instruction to initiate the payment transaction request;
generating the payment transaction request based on the user instruction; and
encrypting the payment transaction request with an encryption key stored at the payment provider server.

20. The method of claim 15 further comprising: adding an identification of the communication device to a tracking list included with the payment transaction request when sending the payment transaction request to the trusted device.

21. The method of claim 20 further comprising:
receiving a payment confirmation generated by the payment provider server for confirming processing of the payment transaction request;
determining whether the communication device is the request originating device based on the tracking list included in the payment confirmation; and
sending the payment confirmation to a next trusted device based on the tracking list if the communication device is not the request originating device.

22. The method of claim 21 further comprising notifying the payment confirmation to a user of the communication device if the communication device is the request originating device.
